(19) United States
(12) Patent Application Publication
(10) Pub. No.: US 2015/0095479 A1
(43) Pub. Date: Apr. 2, 2015

(54) Industrial Security Provisioning

(71) Applicant: Broadcom Corporation, Irvine, CA (US)

(72) Inventors: Xuemin Chen, Rancho Santa Fe, CA (US); Wael William Diab, San Francisco, CA (US); Yongbum Kim, Los Altos Hills, CA (US); Mohan Venkatachar Kalkunte, Saratoga, CA (US)

(73) Assignee: Broadcom Corporation, Irvine, CA (US)

(21) Appl. No.: 14/179,123

(22) Filed: Feb. 12, 2014

Related U.S. Application Data
(60) Provisional application No. 61/885,303, filed on Oct. 1, 2013.
(60) Provisional application No. 61/924,372, filed on Jan. 7, 2014.

(51) Int. Cl. H04L 12/24

(52) U.S. Cl. CPC H04L 41/12
USPC 709/223

(57) ABSTRACT

A device includes a network interface, memory, and logic in data communication with the network interface and memory. The memory is configured to store instructions. When executed by the logic, the instructions are configured to: determine topology information for a node of a network, determine a desired security level for the node based on the topology information, determine a function for the node, determine a security feature to implement the desired security level based on the function, and implement the security feature on the node.

### PRIORITY CLAIM

This application claims the benefit of priority from U.S. Provisional patent application Ser. No. 61/885,303 filed on Oct. 1, 2013 and U.S. Provisional patent application Ser. No. 61/924,372 filed on Jan. 7, 2014, both of which are incorporated by reference herein in their entirety.

### TECHNICAL FIELD

This disclosure relates to communication in an industrial environment. This disclosure also relates to security feature provisioning in an industrial environment.

### BACKGROUND

Rapid advances in sensors, control systems, and manufacturing techniques have led to the worldwide adoption of automated manufacturing techniques for every imaginable product. The manufacturing techniques include automation and process control, and operate in a variety of settings. Personnel, security, and resource availability may vary from site to site.

### BRIEF DESCRIPTION OF THE DRAWINGS

FIG. 1 shows an example of an environment that implements location based security provisioning.

FIG. 2 shows an example security level layout.

FIG. 3 shows example security feature decision (SFD) matrix.

FIG. 4 shows example SFD logic.

FIG. 5 shows another example SFD logic for task based security feature determination.

FIG. 6 shows example logic for node requisitioning for tasks.

FIG. 7 shows an example of an architecture that shows communication among multiple nodes in an industrial environment.

FIG. 8 shows an example of architecture in an industrial environment that supports node relocation.

### DETAILED DESCRIPTION

Communication within and across manufacturing or industrial environments can be difficult due to extreme temperatures, variant levels of dust, moisture, machine noise, chemical hazards, and more. Injected noise in an industrial environment may adversely impact communication reliability and quality in the environment.

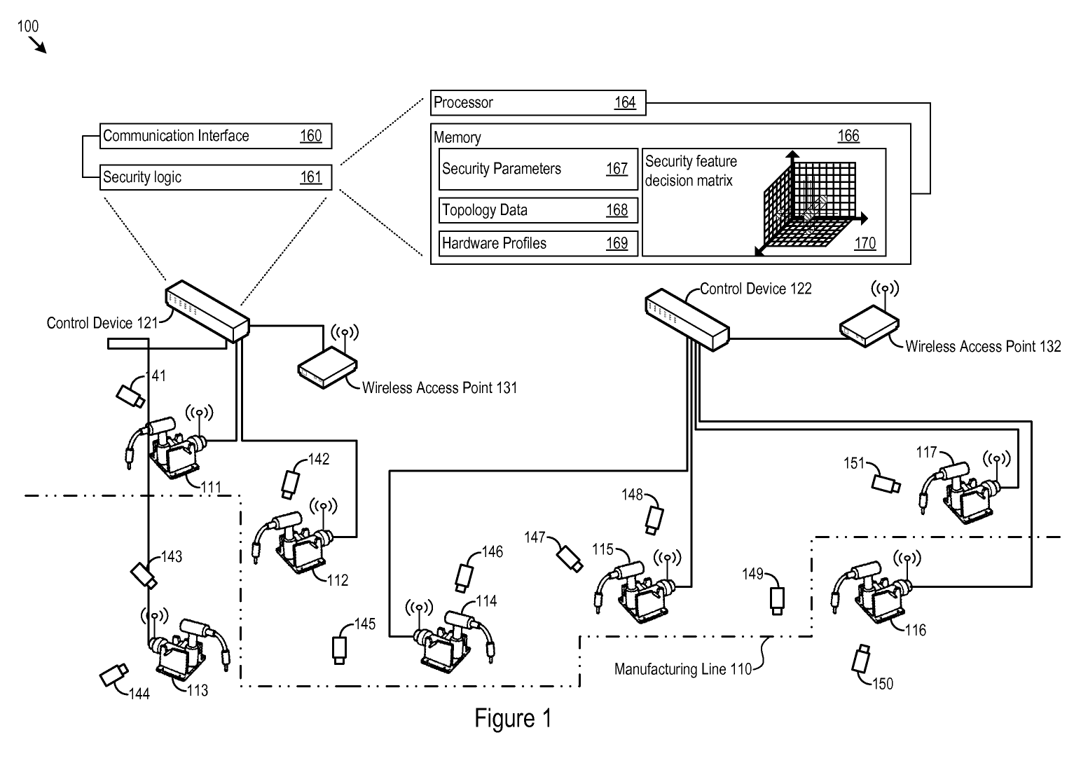

FIG. 1 shows an example of an environment 100 that implements location and/or functionality based security feature provisioning and assignment. The environment 100 may be any industrial environment, such as a manufacturing assembly line, industrial materials processing plant, or factory inventory area. In particular, the environment 100 shown in FIG. 1 is an industrial environment that includes the manufacturing line 110. The environment 100 is not limited to industrial settings, however, and any environment in which the security feature provisioning discussed below might be useful is a possibility, such as within a vehicle, a hospital, television broadcasting studio, or a classroom. For example, data collected by sensors or monitoring devices in a hospital or school may be subject to privacy statutes and may be secured from the time of collection to meet compliance guidelines.

An environment 100 may include any number of nodes. The exemplary industrial environment 100 in FIG. 1 includes manufacturing nodes 111-117, control nodes 121 and 122, wireless access points (AP) 131 and 132, and multiple sensors labeled as sensors 141-151. Additional or alternative nodes may be present in the industrial environment 100, including as examples, nodes such as hubs, switches, routers, or bridges, data servers, actuators, generators, motors, machinery, monitoring nodes, computers, management or control systems, environment management nodes, analysis systems, communication nodes, and any mobile node such as a mobile phone, tablet, and the like.

The manufacturing nodes 111-117 are positioned along the manufacturing line 110. The manufacturing nodes 111-117 may be implemented as any machinery, robotics, actuators, tooling, or other electronics that participate in an assembly (or de-assembly) process along the manufacturing line 110. The manufacturing nodes 111-117 are communicatively linked to control nodes, through which the manufacturing nodes 111-117 receive control signals that monitor, guide, or control the manufacturing nodes 111-117. In FIG. 1, the control node 121 is communicatively linked to the manufacturing nodes 111-113 and the control node 122 is communicatively linked to the manufacturing nodes 114-117. In some variations, the control node 112 is a programmable logic controller (PLC).

The sensors 141-151 may monitor various locations in the industrial environment 100. In FIG. 1, the sensors 141-151 are positioned at predetermined monitoring locations along the manufacturing line 110 and proximate to the manufacturing nodes 111-117. The sensors 141-151 may capture environment data for monitoring the environment 100, such as visual data, audio data, temperature data, positional or movement data, or any other environment data indicative of a characteristic of the industrial environment 100. The sensors 141-151 may communicate captured data to any node in the industrial environment 100, an analysis system, or a monitoring system.

The industrial environment 100 supports multiple communication links between any of the nodes within and/or outside the industrial environment 100. The multiple communication links may provide redundancy or failover capabilities between the communicating nodes. As one such example shown in FIG. 1, the control node 121 is linked to the manufacturing node 111 through both a wired communication path (e.g., through a wired cable) and a wireless communication path (e.g., via the wireless access point 131). The manufacturing nodes 111-117, in that regard, may communicate across multiple technologies, including any number of wired technologies and/or wireless technologies. To support the communication links, the control node 121 and manufacturing nodes 111-117 may include logic to execute communication protocols and security features. For example, the nodes may include master terminal units (MTUs), programmable logic controllers (PLCs), and/or programmable array controllers (PACs). For example, in some implementations, a security feature (e.g. end-to-end encryption) may provide protection on a communication link between an MTU on a controller node and a PLC on a manufacturing node.

A node in the industrial environment 100 may include a communication interface that supports multiple communication links with other nodes within or outside of the industrial environment 100. A communication interface may be configured to communicate according to one or more communication modes, e.g., according to various communication techniques, standards, protocols, or across various networks or topologies. The communication interface may support communication according to particular quality-of-service (QoS) techniques, encoding formats, through various physical (PHY) interfaces, and more. For example, a communication interface may communicate according to any of the following network technologies, topologies, mediums, protocols, or standards: Ethernet including Industrial Ethernet, any open or proprietary industrial communication protocols, cable (e.g. DOCSIS), DSL, Multimedia over Coax Alliance (MoCA), power line (e.g. HomePlug AV), Ethernet Passive Optical Network (EPON), Gigabit Passive Optical Network (GPON), any number of cellular standards (e.g., 2G, 3G, Universal Mobile Telecommunications System (UMTS), GSM (R) Association, Long Term Evolution (LTE) (TM), or more), WiFi (including 802.11 a/b/g/n/ac), WiMAX, Bluetooth, WiGig (e.g., 802.11 ad), and any other wired or wireless technology or protocol. The control node 121, as one example, includes the communication interface 160.

The control node 121 may include security logic 161 for security feature provisioning and/or assignment within the environment 100. The security logic 161 may include one or more processors 164 and memory 166. Memory 166 may include security parameters 167 for implementation of security features. Memory 166 may include topology data 168 for determination of topological regions and hardware profiles 169 for determination of applicable security features for given hardware functions. Additionally or alternatively, memory 166 may include a security feature decision (SFD) matrix 170, which may be used to make security feature implementation decisions based on factors, such as, topological region, function, and/or other factors as described below. The security logic may determine features that may be used to implement security at a desired level. The features implemented may vary among nodes at a given security level. For example, various node functions may use different security features to achieve a specified security level. In some cases, a sensor may lack a user interface. The sensor may not implement security features related to securing human interface devices (HIDs).

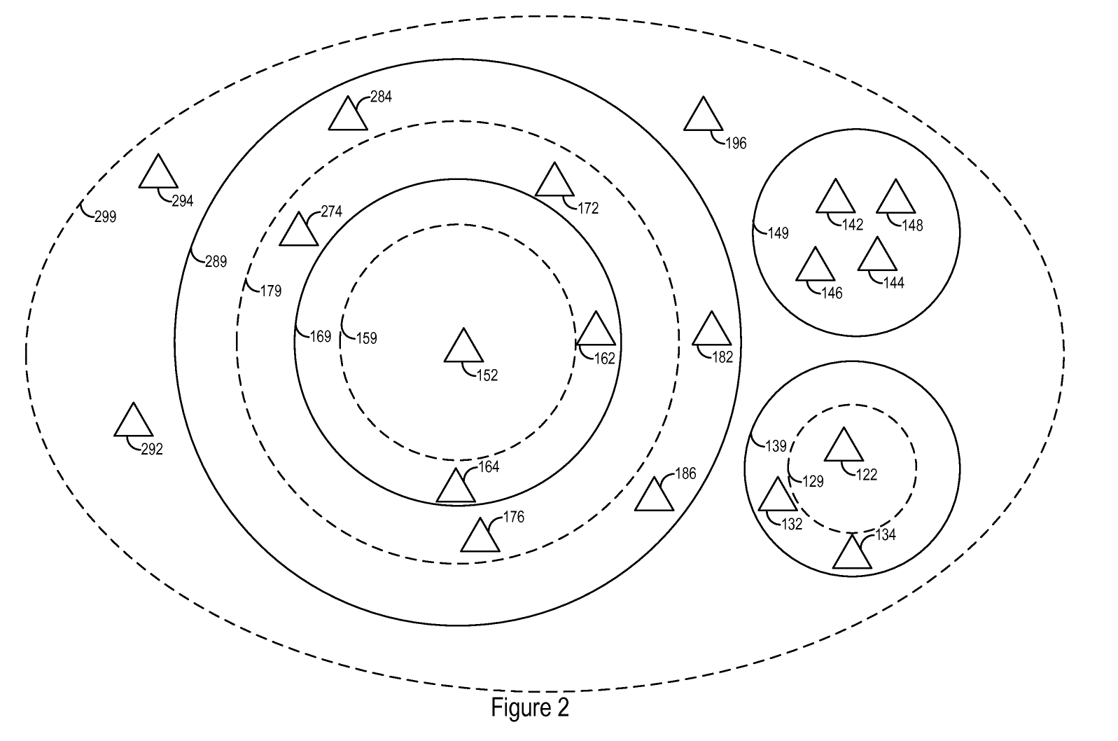

FIG. 2 shows an example security level layout 200. In the example layout 200, the security features may be organized in different layers indicating differing security levels 229, 239, 249, 259, 269, 279, 289, 299. The differing layers may include security features. Security features may include software, hardware, physical characteristics or other features to enhance the security of a node, such as authentication protocols, data encryption, memory protection (physical and logical), key protection, software protection, interfaces, tamper resistant chassis, control busses, or other security features. Security level 129 includes security feature 222, Security level 239 includes security features 232 and 234. Security level 249 includes security features 242, 244, 246, and 248. Security level 259 includes security feature 252. Security level 269 includes security features 262 and 264. Security level 279 includes security features 272, 274, and 276. Security level 289 includes security features 282, 284, and 286. Security level 299 includes security features 292, 294, and 296. Security levels may be layered under other security levels. For example, the security level 259 may protect root access to a machine or network and security feature 252 may be a root key. Security level 259 may be layered under security level 269. For example, level 269 may govern authentication of users to the machine or network. The level 269 may make use of the protection of root access to bar unauthorized users.

In some implementations, security level 269 may be dependent on level 259 and the security feature 252. Similarly, level 279 may be dependent on level 269 and transitively dependent on security level 259. Level 299 may be dependent on 289, which may depend on 279. Some levels may be independent of other levels. For example, security level 249 may be independent of security levels 259, 269, 279, and 289. For example, security features 242, 244, 246, 248 may include physical security features such as tamper evident chassis, tamper resistant components, sealed compartments, self-destruct modules, and/or other physical security features. Security level 289 may include features such as software or hardware interfaces that may not rely on physical security features. Security level 299 may depend on security levels 249 and 289. For example, security level 299 may include a feature that is complaint with a standard that depends on physical security feature (e.g. from security level 249) and software and hardware interface security features (e.g. from security level 289).

Various security features may be implemented. For example, a security feature may include encryption at L2 or L3 for nodes associated with a given controller or function. Another example may include locational security such as providing a power-over-ethernet (PoE) trickle such that nodes may detect being unplugged from a network when powered down and/or in various power modes. Additionally or alternatively, authentication schemes may be implemented as a security feature. For example, nodes may store a signature (e.g. media access control (MAC) address), pass key, or other data that may be mirrored on local databases. This signature and local storage pair may be used to ensure unauthorized nodes (e.g. cloned or counterfeit nodes) are not given access to the environment 100. In some cases, nodes may be provided keys via one-time-provisioning (OTP). For example, in a closed-loop security scheme for a video monitoring system OTP key provision may ensure data collected by the system is not intercepted by an unauthorized node.

Security features and security levels may be implemented in various nodes of the environment 100. The topology of the environment 100 may be mapped. For example, the locations and/or connectivity of the nodes may be monitored or recorded.

Additionally or alternatively, the connectivity map of the network may be used as a topology map. For example, nodes associated with a control node, network switch, access point, or other node may be associated with a topological region. In some cases, internet protocol (IP) address networks and subnets may be used to establish topology.

In some cases, the network topology may be determined based on collected location data. For example, connectivity to a specific access point may establish a physical location. Relative signal strengths from multiple access points or other transmitters may also be used to determine location. In some cases, connectivity to a physical port with a known location may be used to determine location. In some cases, a node, may broadcast a signal and relative received signal strengths at multiple known locations may be used to determine the position of the node. Geolocation systems, such as global positioning system (GPS), Galileo, or other geolocation systems, may be used to determine location.

Based on the network topology, security levels and features may be applied to nodes. Differing topological regions may have different associated security preferences. For example, for an assembly line within a manufacturing plant, multiple security regions may be defined. A first security level may be implemented for the beginning of the assembly line, and a second security level may be implemented for at positions performing sensitive operations. For example, a second security level may be implemented on a computer controlled machining station stores customer product designs to help reduce the chances of theft of the designs.

In some cases, the network topology may determine a maximum security level for a given topological region. For example, to communicate over encrypted data channels, a node may include security keys and/or certificates. In some cases, nodes may be lost or stolen and may compromise the encryption of some data channels. In some cases, nodes in unsecure areas (e.g. areas of unrestricted access, third-party traffic, and/or other unsecure areas) may have increased vulnerability to theft. In response, nodes in unsecure areas may not include some security keys and/or certificates. The nodes may not be able to support certain encryption schemes without the associated security keys and/or certificates. Lacking support of some security features may cap the security levels that can be met by the node. In some cases, the network topology may determine a minimum security level for a given topological region. In some cases, nodes in a given topological region may handle sensitive information and/or materials, minimum security levels for these nodes may reduce the chance of data breaches.

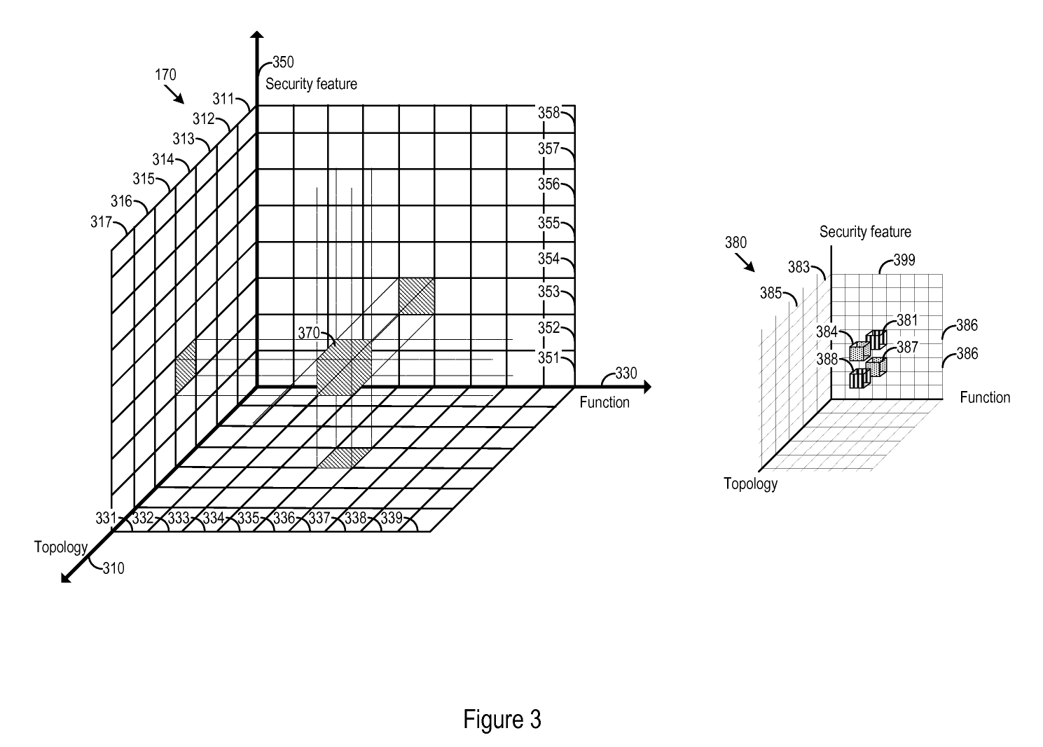

The differing preferences may be used to determine security features for nodes. FIG. 3 shows example SFD matrix 170. The SFD matrix 170 may be used by a node, e.g., control node 121, to determine a security feature set for itself or any other. As examples of dimensions of the SFD matrix 170, the topology dimension 310 represents the topology input for the SFD matrix 170. A network node may be disposed in one or more topological regions, several of which are labeled 311-317. For instance, the topological region 311 may be a location on the factory floor, while topological region 312 may be in a control room above the factory floor.

As another example dimension of the SFD matrix 170 is the function dimension 330. A node may execute one or more functions, examples of which are labeled 331-339. For example, the functions 331-339 may include monitoring, manufacturing, control, transport, sensing, sampling, data communication, and/or other functions.

The example SFD matrix 170 shows 7 possible regions and 9 possible functions. However, other numbers of possible functions and topological regions are possible. The number of possibilities may be determined by the network and the operational environment of the network. The axis 350 shows the security feature 351-358 for which an implementation decision is made using the SFD matrix 170. For the security feature 351-358 and the topological 310 and functional 330 inputs, the grid point may include an implementation decision. For example, the grid point 370 corresponds to the topological region 314, the function 335, and the security feature 353. For example, topological region 314 may implement security feature 353 and the security feature 353 may be applicable to function 335. In this case, grid point 370 may indicate implementation of security feature 353. In another example, topological region 314 may implement security feature 353 and security feature 353 may not apply to function 335. In this case, grid point 370 may indicate that security feature 353 is not implemented. In yet another example, security feature 353 may not be implemented for topological region 314. In this case, grid point 370 may indicate that security feature 353 is not implemented. Additionally or alternatively robustness and redundancy features and preferences may be considered via the SFD matrix 170.

In an example case 380, gird point 381 may correspond to a positive implementation decision for security feature 382, e.g. advanced encryption standard (AES) 256-bit encryption at topological region 383 and for a given function 399 (e.g., video streaming). Grid point 384 may correspond to the same security feature 382, but may correspond to a different topological region 385. Grid point 384 may indication a negative implementation decision for AES 256-bit encryption. Grid points 387 and 388 may correspond to security feature 386, AES 64-bit encryption, at topological regions 383 and 385, respectively. Conversely, 387 and 388 may indicate negative and positive decisions. This may correspond to AES 256-bit encryption being used in topological region 383, e.g., a physically unsecure location, and 64-bit encryption being used in topological region 385, e.g., a physically secure region.

Additionally or alternatively, the security features implemented may depend on network layers. For example, in an industrial environment, a node may access and/or transmit data encapsulated a various network layers (e.g., MAC layer, transport layer, application layer, PHY layer, or other layer. Network security feature virtualization may be mapped to the different layers. In some implementations, the network layers, may be mapped to positions on an axis (e.g., an existing or additional axis) of the grid of SFD matrix 170.

Additionally or alternatively, the size of a node may be considered in security provisioning. For example, nodes of small physical size may be more easily stolen. Thus, sensitive data, such as network encryption keys, may not be preferably stored on small nodes, which could potentially be concealed in a pocket, bag, or other container. In some cases, some nodes may not support a given security feature because the data and of logic to support that feature may not be preferred for nodes of a given size. Size considerations may be mapped to dimensions of the SFD matrix 170. For example, classification along the size axis may correspond to equipment involved in moving the node. For example, a low classification may be given to nodes that may be carried by a person. Higher classifications may be given to nodes that can be moved via forklift and/or are immobile. Other features such as mobility, value, criticality (e.g. an element needed for proper operation of an assembly line) may be used.

Additionally or alternatively, matrix dimensions, e.g. topology and function, may be added or eliminated in some implementations. In some cases, the SFD matrix 170 may take a 2-dimensional, 3-dimensional, and/or n-dimensional form. The dimensions may represent the inputs to the matrix (e.g., topology, function, size, and/or other factors) and the security features for which implementation decisions are being made. The grid points indicate, or in some cases mandate, positive or negative implementation decisions for the security feature.

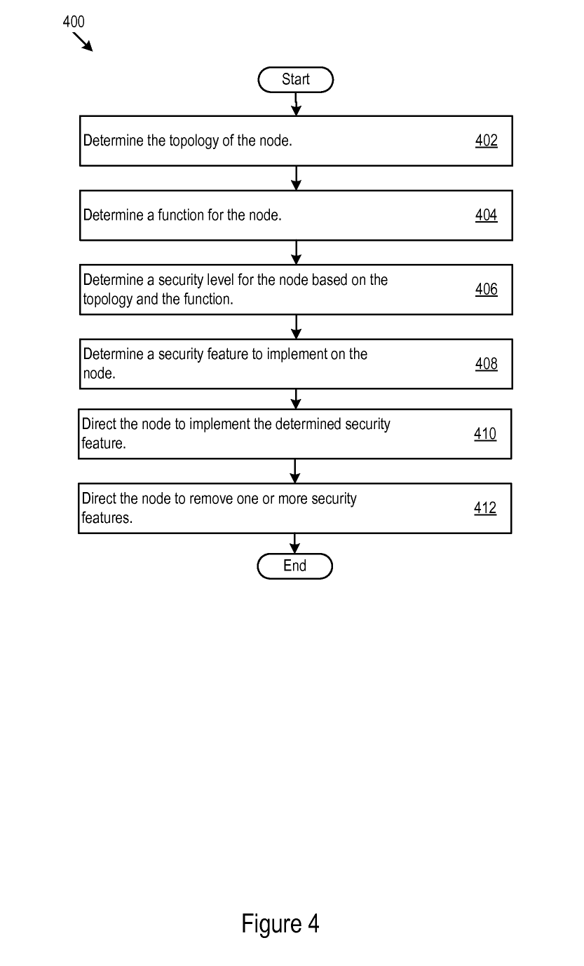

FIG. 4 shows example SFD logic 400. The SFD logic 400, may be used to determine security feature for various nodes. In some cases, the SFD logic 400 may be implemented on control node 121. The SFD logic 400 may determine the topological region of the node (402). For example, as discussed above, the SFD logic 400 may determine a location of the node to determine the node's topology. The SFD logic 400 may determine a function for the node (404). A node may perform one or more functions. Based on the topology of the node (e.g. the node's topological region(s)) and/or the function(s) of the node, the SFD logic 400 may determine a security level for the node (406). For example, the topology of the node may be used to determine a security level range (e.g. minimum and/or maximum levels). The function of the node may be used to determine which security level within the range may be achieved. For example, a camera may not include capabilities for one or more features associated with a first security level. The camera may include capabilities associated with a second level. If the first and second levels are allowed for the topology, the second level may be selected for the camera. Based on the determined security level, the SFD logic 400 may determine a security feature to implement on the node (408). The SFD logic 400 may determine the security features associated with the determined security level to determine which security features to implement.

In various implementations, the SFD logic 400 may apply SFD matrix 170 in making implementation determinations for security features.

The SFD logic 400 may then direct the node to implement the determined security features (410). In some cases, the SFD logic 400 may support the implementation of the features at the node. For example, the SFD logic 400 may provide (or direct the provision of) software to the node to support a feature. In various cases, a hardware module (e.g. a security co-processor, a storage expansion, secure memory, sensors, and/or other hardware module) may be added to the node to support a feature. This hardware addition may be performed by an operator or an automated hardware provisioning node (e.g. a robot capable of pugging a module into a slot). For example, a node lacking software for an encryption feature may be provided such software so that the node may implement the encryption feature. Additionally or alternatively, the SFD logic 400 may direct the node to remove one or more security features active on the node (412). For example, the node may be transitioning from a security level above the maximum level for the determined topology. The SFD logic may direct the node to removal security features associated with levels above the maximum security level. The SFD logic 400 may support the removal of security features. For example, the SFD logic 400 may direct the node to delete locally stored network keys, uninstall software, or to delete sensitive data that may be at risk within the determined topology. Similarly, hardware modules may be removed from the node to reduce security feature capabilities.

In some implementations, nodes may be provisioned based on tasks to be completed. For example, an automated manufacturing facility may receive an order for a number of units of a given product. To meet the order specifications, one or more nodes may be added to a manufacturing line. Other nodes currently requisitioned for the manufacturing line may be left unused in the new manufacturing process. Such unused nodes may be reassigned to other tasks. In another example, nodes involved in environmental monitoring and/or closed loop security systems may be associated with a determined task. Additionally or alternatively, a task may also serve as an input for determining security levels and/or security features.

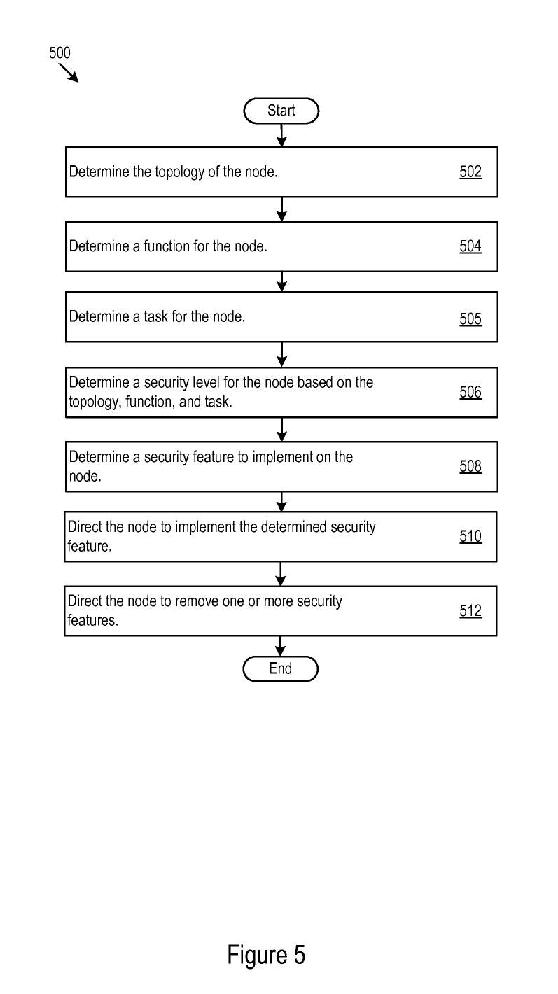

FIG. 5 shows another example SFD logic 500 for task based security feature determination. The SFD logic 500 may determine the topology of the node (502). The SFD logic 500 may determine a function for the node (504). The SFD logic may determine a task for the node (505). For example, the SFD logic may assign the node to a manufacturing group tasked with completing a customer order. Based on the topology of the node (e.g. the node's topological region(s)) and/or the function(s) of the node and the assigned task, the SFD logic 500 may determine a security level for the node (506). Based on the determined security level, the SFD logic 500 may determine a security feature to implement on the node (508). The SFD logic 500 may then direct the node to implement the determined security features (510). Additionally or alternatively, the SFD logic 500 may direct the node to remove one or more security features active on the node (512). For example, the node may be transitioning from a task involving access to sensitive data to a task not using such access. The features supporting access to the sensitive data may be removed to ensure that access to such sensitive data is not broader than usage of the data.

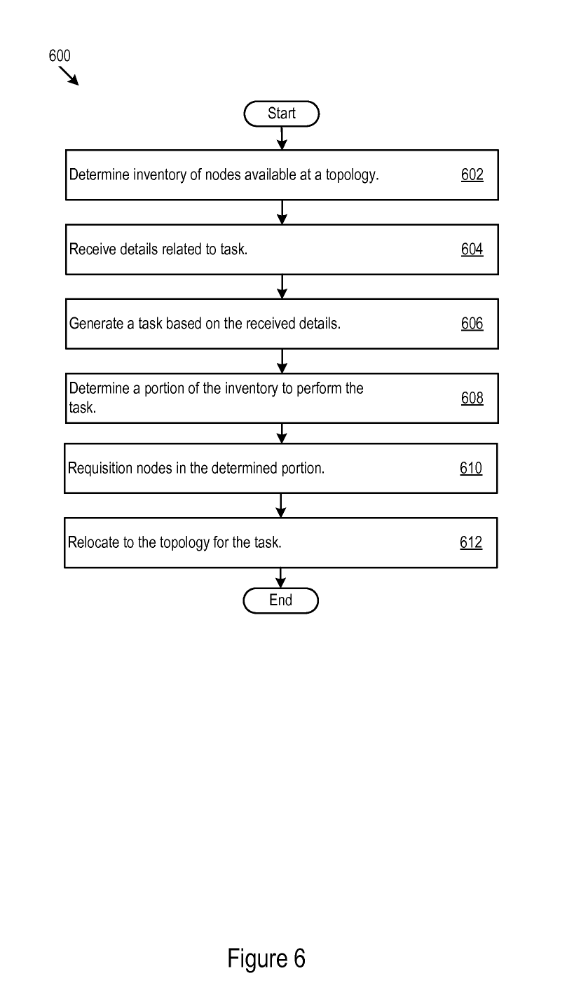

FIG. 6 shows example logic 600 for node requisitioning for tasks. The logic 600 may determine one or more inventories of nodes available at one or more given topologies (602). For example, the logic may determine which nodes are within a determined location and/or can be relocated to the determined location (e.g. portable and/or nomadic nodes). In some cases, the inventory may include nodes assigned to tasks and nodes currently unassigned. Nodes that may be relocated to new topologies may have the capability to implement the security features compliant with the new topology. For example, nodes that lack the capability to comply with the security feature preferences for a topology may not be included in the inventors for that topology. The logic 600 may receive details related to one or more tasks (604). For example, in an industrial manufacturing setting, the logic 600 may receive an order for units of a product. Based on the received details, the logic 600 may generate one or more tasks (606). For example, consistent with the above example, the logic 600 may divide the order into one or more tasks. The logic 600 may determine a portion of the inventories to perform the tasks (608). The logic 600 may requisition the nodes in the determined portion (610). For example, the logic 600 may pass the identifications of the nodes in the determined portion to the SFD logic 500 for feature provisioning prior to engaging the nodes in the task. Additionally or alternatively, the logic 600 may instruct nodes to be relocated to the topology for the task (612). For example, the logic 600 may instruct a nomadic node to travel to the one or more topological regions associated with the task.

In some cases, the logic 600 may react to a status change of a node. For example, a previously requisitioned node may fail and a functional replacement may be sought from the inventory. In another example, an active node may be reassigned to a priority task. Another node may be sought to replace the reassigned node and/or load re-balancing may be applied.

In some implementations, the logic 600 may react to a status change in an environmental parameter or condition. For example, a sensor may detect a rise in the level of oxygen in a given area. The logic 600 may receive an indicator from the sensor. In response, the logic 600 may generate a task to address the oxygen level increase. The logic 600 may requisition nodes to execute the task.

Additionally or alternatively, the logic 600 may generate tasks which are independent of topology. For example, a data processing task may be distributed to nodes in differing topologies which meet the security preferences for the task. In some cases, the logic 600 may be unaware of the topology of the nodes to which the task is distributed. In such cases, the logic 600 may base task requisition on functionality and implemented security features.

In some implementations, nodes may cooperatively act to complete provisioning. For example, nodes may be equipped with radio access technologies (RATs) and may provide security feature support to other commonly assigned nodes via ad hoc networking. For example, a node may be equipped with near field communications (NFC) or the radio frequency identification (RFID) technology, Bluetooth, or WIFI. The node may pass security feature parameters or other data from an origin node to a destination node using the ad hoc networking (e.g. in a chain). In some implementations, to secure the ad hoc bridging between nodes, a multiple-stage key exchange may be used. Additionally or alternatively, end-to-end encryption may be applied to the transmitted parameters or data. For example, chained nodes may not be commonly assigned to tasks or present in the same topology. End-to-end security may allow passage of data over chained nodes where one or more of the intermediate nodes are not authorized to receive the transmitted data.

Additionally or alternatively, ad hoc networking may be used to in location determination of nodes. For example, nodes within the range of NFC communications with a determined node may be determined to be in the same topology. For example, a central node may be in NFC proximity to one or more satellite nodes. The topology of the satellite nodes may then be determined based on the topology of the central node.

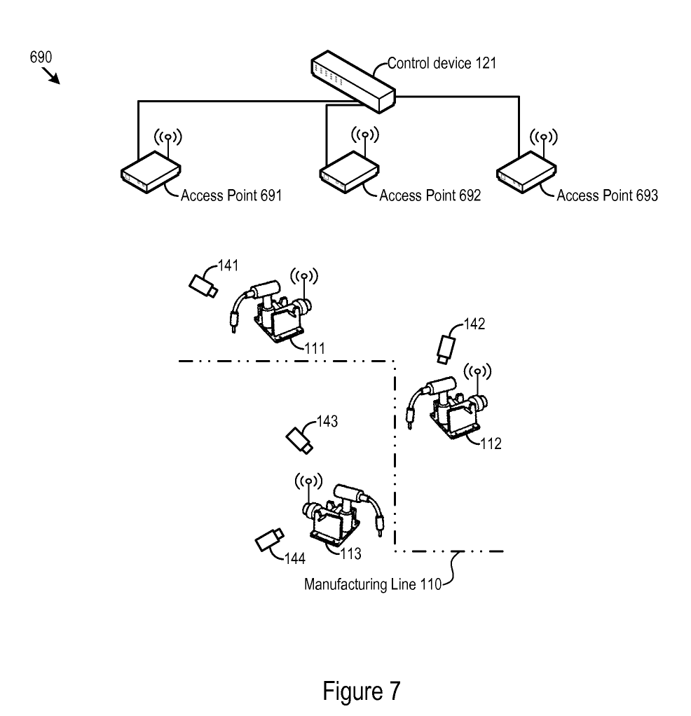

FIG. 7 shows an example of an architecture 690 that shows communication among multiple nodes in an industrial environment. In this regard, nodes in an industrial environment 100 may communicate through multiple different communication pathways, which may utilize different communication resources and/or nodes. In the example architecture 690, the control node 121 may communicate with the manufacturing node 113 through multiple communication pathways. In particular, the control node 121 is linked to the multiple access points labeled as access point 691, access point 692, and access point 693 through which the control node 121 may send a wireless communication to the manufacturing node 113 or other nodes in the industrial environment 100. The redundant pathways may allow a node to select (or be instructed to select) a pathway complaint with the security features implemented on the node. For example, multiple nodes in the same topological region may be assigned to tasks with differing associated security feature preferences. The nodes may select different pathways to comply with the differing preferences. Additionally or alternatively, the redundant multiple pathways may be used to increase the robustness of the network and/or for node location determination. In some implementations, the access points 691, 692, 693 may operate using different RATs to support an array of different security features.

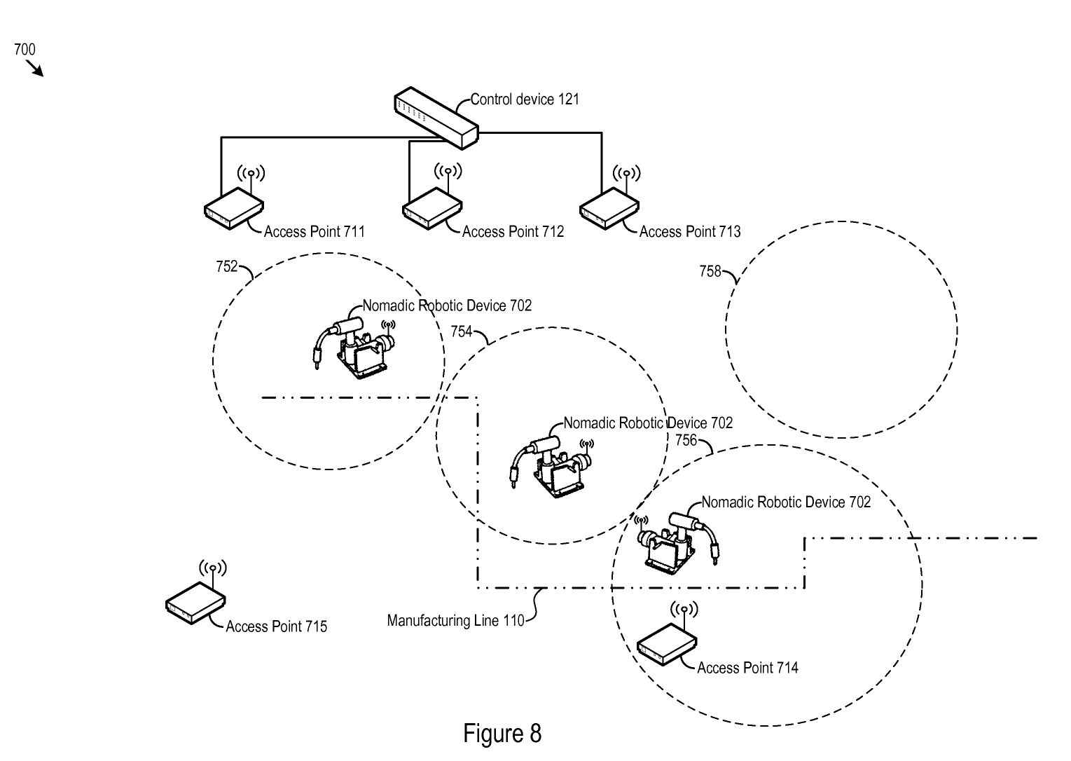

FIG. 8 shows an example of architecture 700 in an industrial environment that supports node relocation. In FIG. 8, a control node 121 is communicatively linked to multiple access points labeled as 711, 712, and 713. The architecture 700 includes the access points 714 and 715, which may be communicatively linked to other control nodes or the control node 121. In some cases, the access points may cover different topological regions. The multiple access points 711-715 may support multiple pathways for communications to a destination node.

Reprovisioning of security features in an industrial environment may be particularly useful in ensuring security preference compliance for non-stationary nodes. Examples of non-stationary nodes include mobile nodes, such as tablets, laptops, smartphones, other mobile computing devices, the nomadic robotic node 702 shown in FIG. 8, or other nodes that are not tied to a particular location, such as mobile patient monitoring nodes or carted medical equipment in a medical environment, mobile sensing nodes, and more. In some cases, SFD logic (e.g. 400, 500) may be disposed on a mobile computing device or nomadic node. Additionally or alternatively, the status of the SFD logic may change, e.g. failure, failover load balancing. The security access and provisioning capabilities of the SFD logic may be changed accordingly.

In FIG. 8, the nomadic robotic node 702 may traverse various positions along the manufacturing line 110 during an assembly process, including the topological regions 752, 754, 756, 758. Broadcasts to the nomadic robotic node 702 from the multiple access points 711-715 may be used to determine the location of the nomadic node via relative signal strengths of the access points. When transmitting or receiving the nomadic robotic node 702 may use one or more of the data pathways provided by the multiple access points 711-715 in accord with the security features implemented on the nomadic robotic node 702.

Additionally or alternatively, redundancy and/or robustness preferences may be determined based on topology. The robustness and redundancy preferences may be treated as security feature for implementation. For example for a particular location or task a determined number of available unassigned manufacture nodes may be kept in reserve for statistically predictable failures. For example, the failure rate for a determined manufacturing node may be 1 failure per 100 nodes per year for a given climate. For a task using 36,500 nodes, failures may occur nearly daily. If the mean downtime is 24 hours per failure, a reserve of one or more nodes may be preferable. Robustness and redundancy considerations may be applied to other nodes in the industrial environment 100.

The methods, devices, nodes, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

Various implementations have been described. However, many other implementations are also possible.

What is claimed is:

1. A method, comprising:
determining topology information for a first node of a network;
determining a function of the first node;
based on the function and the topology information, determining a security feature; and
implementing the security feature at the first node.

2. The method of claim 1, wherein determining the topology information comprises determining a location for the first node.

3. The method of claim 2, wherein the determination of the location is based on a parameter of the network.

4. The method of claim 2, wherein the determination of the location is based on a location service.

5. The method of claim 1, wherein determining the security feature for the first node comprises determining a hardware profile of the first node.

6. The method of claim 5, wherein determining the security feature comprises determining allowed security options associated with the hardware profile.

7. The method of claim 6, wherein the allowed options for the hardware profile are based on a size of the first node.

8. The method of claim 1, wherein determining the security feature comprising determining a maximum security level for the first node based on the topological information.

9. The method of claim 1, wherein determining the security feature comprising determining a minimum security level for the first node based on the topological information.

10. The method of claim 1, further comprising implementing the security feature at a second node in response to a status change at the first node.

11. The method of claim 10, wherein the first and second node have the same topology information.

12. The method of claim 10, wherein status change comprises the first node going offline.

13. The method of claim 1, further comprising responsive to a task change, adding a second node to a task group associated with the first node.

14. The method of claim 13, wherein adding the second node comprises implementing another security feature on the second node.

15. A method, comprising:
determining a location of a first node of a network;
determining a security preference for the location;
based on the security preference, determining a security level for the first node;
determining a function of the first node;
determining a security feature for the security level;
based on the function, determining support for the security feature by the node; and
when the node supports the security feature, causing the first node to implement the security feature.

16. The method of claim 15, further comprising assigning the first node to a task group based on the function and the location.

17. The method of claim 16, further comprising assigning a second node to the task group based on a status of the first node.

18. The method of claim 15, wherein the location comprises a position along a manufacturing chain.

19. A system, comprising:
a network;
a function node interconnected by the network, the function node configured to:
implement security features;
perform a function within a task group;
a control node interconnected to the functional node by the network, the control node configured to:
determine a first location of the function node;
determine the task group for the function node;
based on the determined first location and the task group, determine a first security level for the functional node;
based on the function of the node and the first security level, determine a selected feature of the security features to implement;
cause the function node to implement the selected feature; and
assign the function node to the task group.

20. The system of claim 19, wherein:
the function node comprises a nomadic node; and
the control node is further configured to:
instruct the node to relocate to a second location; and
based on the second location determine a second security level.
